(19) United States
(12) Patent Application Publication
(10) Pub. No.: US 2014/0129755 A1
(43) Pub. Date: May 8, 2014

(54) EXTERNAL BOOST OF PROCESSING THROUGH A DATA PROCESSING DEVICE

(71) Applicants: Mahesh Sambhaji Jadhav, Sangli (IN); Rupesh Deorao Chirde, Yavatmal (IN)

(72) Inventors: Mahesh Sambhaji Jadhav, Sangli (IN); Rupesh Deorao Chirde, Yavatmal (IN)

(21) Appl. No.: 13/670,752

(22) Filed: Nov. 7, 2012

(51) Int. Cl. G06F 13/36

(52) U.S. Cl. 710/305

(57) ABSTRACT

A method includes providing a non-motherboard level Input/Output (I/O) interface in a data processing device including a processor communicatively coupled to a memory, and providing a driver component of an external processor in the memory of the data processing device and/or a memory associated with the external processor. The method also includes installing the driver component in the data processing device to render the data processing device compatible with the external processor, and coupling the external processor to the data processing device through the non-motherboard level I/O interface to provide boosting of processing through the data processing device, thereby dispensing with a need to make a motherboard level modification in the data processing device therefore.

### FIELD OF TECHNOLOGY

This disclosure relates generally to data processing devices and, more particularly, to externally boosting processing through a data processing device.

### BACKGROUND

A data processing device (e.g., a personal computer, a laptop computer, a notebook, a netbook, an ultrabook, a mobile device such as a mobile phone) may be limited in processing capability by a processor (e.g., Central Processing Unit (CPU)) thereof. In order to boost processing capability (e.g., graphics capability), a user of the data processing device may have to make a motherboard level modification in hardware in order to accommodate a supplementary processor (e.g., a graphics processor in a graphics card) by providing, for example, a Peripheral Component Interconnect Express (PCIe) interface or an Advanced Graphics Port (AGP). Even when the aforementioned interfaces are provided in the motherboard, the user (or, service personnel) may have to manually insert the graphics card into an appropriate slot of the motherboard, which may prove to be tedious.

### SUMMARY

Disclosed are a method, a device and/or a system of externally boosting processing through a data processing device.

In one aspect, a method includes providing a non-motherboard level Input/Output (I/O) interface in a data processing device including a processor communicatively coupled to a memory, and providing a driver component of an external processor in the memory of the data processing device and/or a memory associated with the external processor. The method also includes installing the driver component in the data processing device to render the data processing device compatible with the external processor, and coupling the external processor to the data processing device through the non-motherboard level I/O interface to provide boosting of processing through the data processing device, thereby dispensing with a need to make a motherboard level modification in the data processing device therefore.

In another aspect, a system includes a data processing device and an external processor. The data processing devices includes a memory, a processor communicatively coupled to the memory, and a non-motherboard level I/O interface. The external processor includes a memory associated therewith. The memory of the data processing device and/or the memory associated with the external processor include a driver component of the external processor therein. The driver component is installed in the data processing device to render the data processing device compatible with the external processor. The external processor is configured to be coupled to the data processing device through the non-motherboard level I/O interface to provide boosting of processing through the data processing device, thereby dispensing with a need to make a motherboard level modification in the data processing device therefore.

In yet another aspect, a system includes a data processing device and an external processing boosting device. The data processing device includes a memory, a processor communicatively coupled to the memory, and a non-motherboard level I/O interface. The external processing boosting device includes an external processor having a memory associated therewith. The memory associated with the external processor includes a driver component of the external processor stored therein. When the external processing boosting device is coupled to the data processing device through the non-motherboard level I/O interface, device information of the external processing boosting device is read through an operating system executing on the data processing device in conjunction with the processor thereof.

The operating system of the data processing device in conjunction with the processor thereof is configured to assign a unique identifier to the external processing boosting device following the reading of the device information. The driver component is loaded from the memory associated with the external processor into the memory of the data processing device following the assignment of the unique identifier. The driver component is configured to be installed from the memory of the data processing device to enable identification of the external processor during a subsequent coupling thereof to the data processing device through the non-motherboard level I/O interface, thereby enabling the external processing boosting device to provide boosting of processing through the data processing device, with a need to make a motherboard level modification in the data processing device therefore being dispensed with.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of an external processor of FIG. 1, according to one or more embodiments.

FIG. 3 is a schematic and a perspective view of an example external processing boosting device including the external processor of FIG. 1.

FIG. 4 is a schematic and a perspective view of an example external processor of FIG. 1 having a heat sink associated therewith.

FIG. 5 is a schematic view of an example data processing device of FIG. 1 with the external processor being coupled thereto through a Thunderbolt™ interface.

FIG. 6 is a process flow diagram detailing the operations involved in externally boosting processing through the data processing device of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of externally boosting processing through a data processing device. Although the present embodiments have been described with reference to specific example embodiments, it will be evident that various modifications and changes may be made to these embodiments without departing from the broader spirit and scope of the various embodiments.

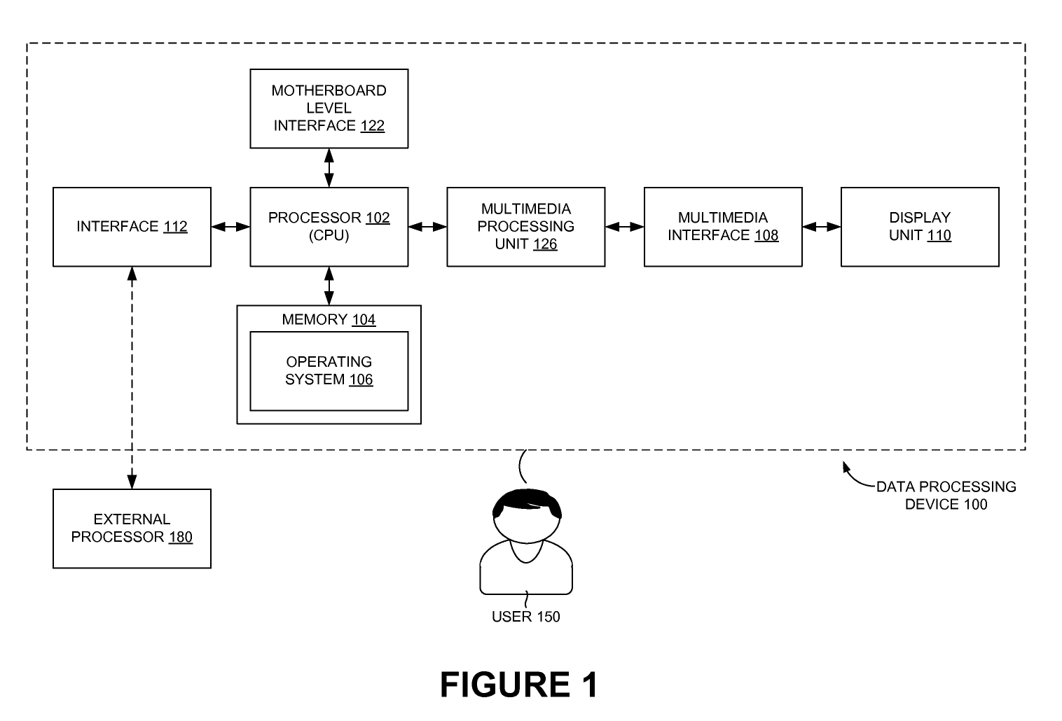

FIG. 1 shows a data processing device 100, according to one or more embodiments. An example data processing device 100 may include but is not limited to a desktop computer, a laptop computer, a notebook computer, a netbook, an ultrabook, a tablet and a mobile device such as a mobile phone. In one or more embodiments, data processing device 100 may include a processor 102 (e.g., Central Processing Unit (CPU), Graphics Processing Unit (GPU)) communicatively coupled to a memory 104, processor 102 being configured to address storage locations in memory 104. In one or more embodiments, memory 104 may include a volatile memory (e.g., Random Access Memory (RAM)) and/or a non-volatile memory (e.g., Read-Only Memory (ROM), hard disk).

In one or more embodiments, output data associated with processing through processor 102 may be input to a multimedia processing unit 126 configured to perform encoding/decoding associated with the data. In one or more embodiments, the output of multimedia processing unit 126 may be rendered on a display unit 110 (e.g., Liquid Crystal Display (LCD) display, Cathode Ray Tube (CRT) monitor) through a multimedia interface 108 configured to convert data to an appropriate format required by display unit 110.

It is obvious that an operating system 106 may execute on data processing device 100. FIG. 1 shows operating system 106 as being stored in memory 104 (e.g., non-volatile memory). In one or more embodiments, an interface 112 coupled to processor 102 may be provided in data processing device 100 to enable coupling of an external processor 180 thereto. Here, external processor 180 may be interpreted as an Input/Output (I/O) device by processor 102. For example, interface 112 may be a high-speed I/O port (e.g., a Universal Serial Bus (USB) port or a Thunderbolt™ port enabling coupling of external processor 180 through a corresponding USB cable or Thunderbolt™ cable). In one or more embodiments, external processor 180 may serve to boost processing (e.g., graphics processing) associated with data processing device 100. In one example embodiment, external processor 180 may be an external Graphics Processing Unit (GPU). Other processors are also within the scope of the exemplary embodiments discussed herein.

FIG. 1 shows processor 102 as a CPU also interfaced with a motherboard level interface 122 (e.g., Peripheral Component Interconnect Express (PCIe), Accelerated Graphics Port (AGP)) to enable coupling of a graphics card including a GPU. Utilization of motherboard level interface 122 may necessitate hardware-level modification such as providing an appropriate slot (e.g., PCIe slot, AGP slot) on the motherboard including processor 102. It is to be noted that the CPU example of processor 102 and motherboard level interface 122 are merely to illustrate that the aforementioned motherboard level interface 122 is an internal solution, in contrast to interface 112 that allows for an external processor 180 to be coupled (i.e., a non-motherboard level solution).

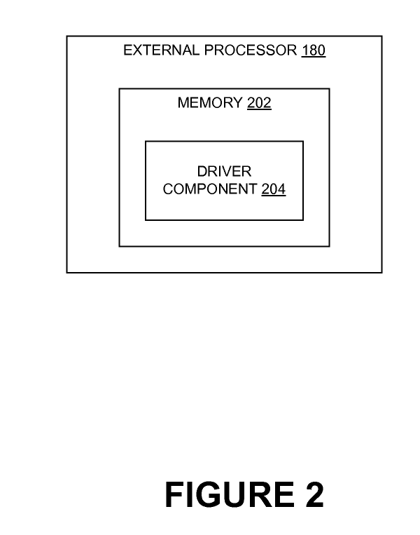

FIG. 2 shows a schematic of external processor 180, according to one or more embodiments. In one or more embodiments, external processor 180 may include a memory 202 associated therewith, with memory 202 including a driver component 204 (a set of instructions). It is obvious that memory 202 may be external to external processor 180 in an alternate embodiment. In one or more embodiments, driver component 204 may be packaged with appropriate libraries to enable compatibility with operating system 106 associated therewith. In one or more embodiments, when external processor 180 is coupled to interface 112 of data processing device 100, data processing device 100 may communicate with external processor 180 to read device information (e.g., through operating system 106 in conjunction with processor 102) associated therewith.

In one or more embodiments, following the reading of the device information, external processor 180 may be assigned a unique identifier (e.g., through operating system 106 in conjunction with processor 102). Then, in one or more embodiments, driver component 204 is loaded into data processing device 100, following which driver component 204 (and associated library files) may be installed in data processing device 100. In an example embodiment, a user 150 of data processing device 100 may be prompted through operating system 106 to install driver component 204.

In one or more embodiments, once driver component 204 is installed in data processing device 100, external processor 180 may merely need to be plugged in for usual use thereof during subsequent times as file(s) associated with driver component 204 are saved in data processing device 100 as system file(s) and detection of external processor 180 merely is based on the unique identifier assigned (and stored in data processing device 100). It is obvious that instructions associated with driver component 204 (and associated library files) may be embodied in a non-transitory medium (e.g., Compact Disc (CD), Digital Video Disc (DVD)). The aforementioned non-transitory medium may be readable through data processing device 100 and instructions associated with driver component 204 (and associated library files) executable therethrough. It is to be noted that a hard drive is also an example of a non-transitory medium. For example, driver component 204 (and associated library files) may be available as a download from the Internet. After being downloaded to a hard drive of data processing device 100, driver component 204 may then be installed therein.

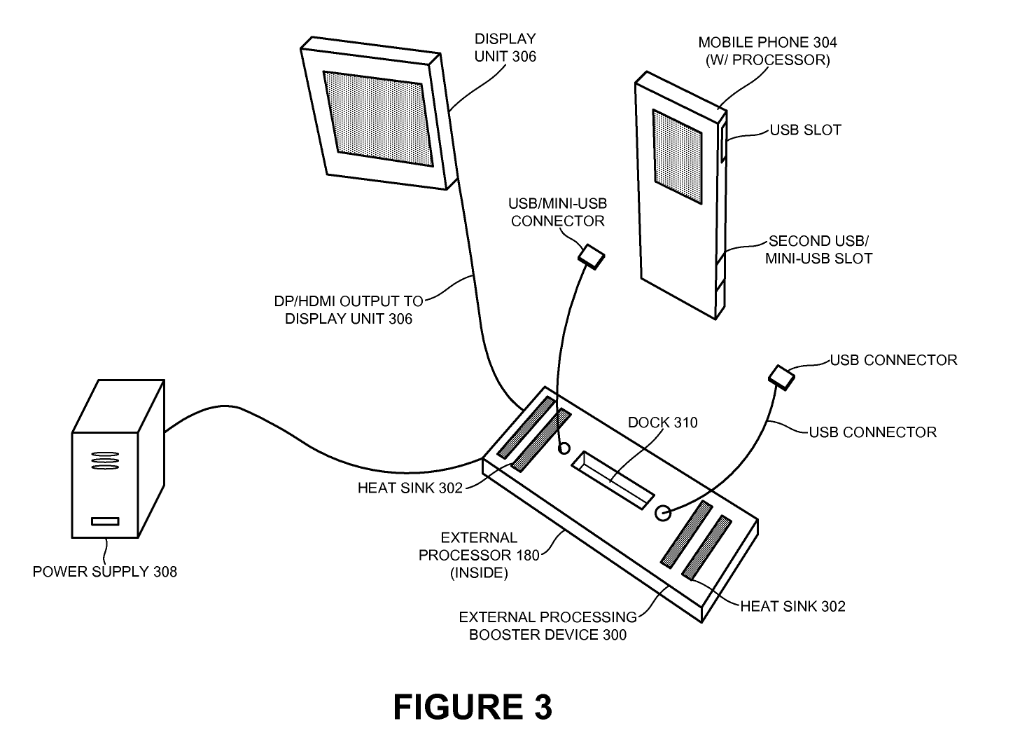

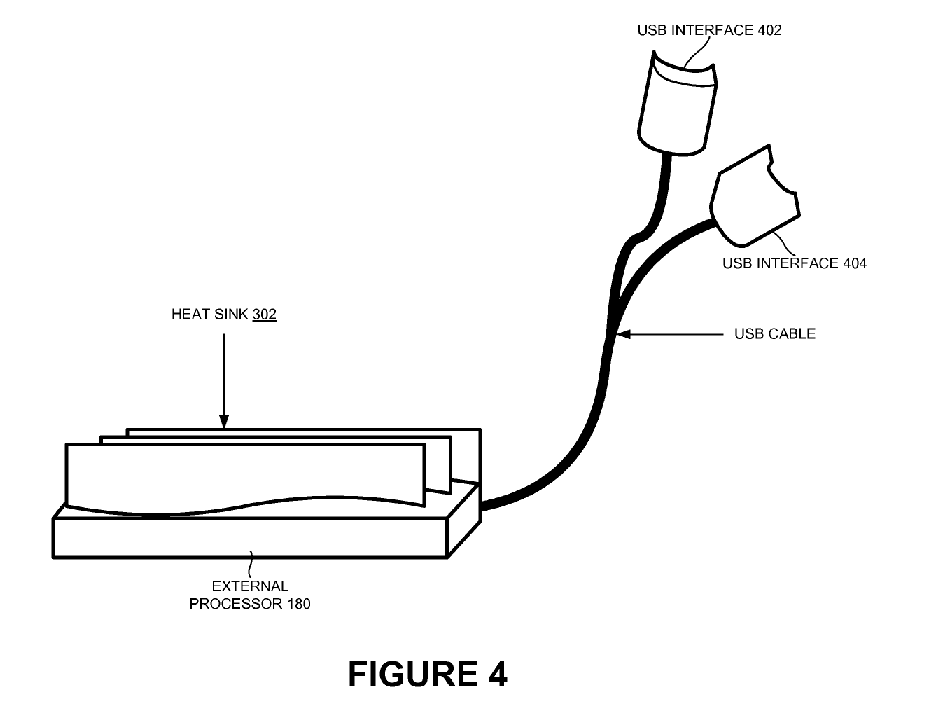

FIG. 3 shows external processing booster device 300 (e.g., a graphics card) including external processor 180, according to one or more embodiments. In one or more embodiments, external processing booster device 300 may include external processor 180 (not shown because of being hidden within external device 300) having a heat sink 302 (also shown in FIG. 4) associated therewith. Heat sink 302 may allow for cooling of external processor 180 by dissipating heat generated therethrough into the surroundings. In FIG. 3, external processing booster device 300 is shown to include a mini USB/USB connector and a USB connector (examples of interface 112) for illustrative purposes. The aforementioned connectors may enable coupling of a mobile phone 304 (example data processing device 100) to external processing booster device 300.

The function of external processor 180 may not be limited to boosting processing in data processing device 100. The output of external processor 180 may also be coupled to a display unit 306 (e.g., same as display unit 110, different display unit) in order to render data therefrom. For example, external processor 180 may be coupled to a television or a computer monitor through a DisplayPort (DP)/mini-DP interface, High-Definition Multimedia Interface (HDMI) interface and the like. The aforementioned configuration may enable external processing booster device 300 to utilize a processor (e.g., graphics processor) of mobile phone 304 along with external processor 180 to provide High-Definition (HD) video output (and/or gaming experience) on display unit 306. Thus, video processing and/or game content may be performed by both the processor of mobile phone 304 and external processor 180.

FIG. 3 also shows an external power supply 308 coupled to external processing booster device 300. Also, external processing booster device 300 may include a dock 310 (e.g., a slot) to hold mobile phone 304 and/or charge a battery thereof. It is obvious that the USB connectors may directly be coupled to display unit 306 in order to render data thereon. Thus, external processing booster device 300 may, for example, serve as a graphics booster between data processing device 100 (e.g., mobile phone 304) and display unit 306.

It is obvious that external processing booster device 300 is not limited to the implementation discussed with regard to FIG. 3. FIG. 4 shows external processor 180 with heat sink 302 shown in more detail, according to one or more embodiments. Also, FIG. 4 shows two USB interfaces (402, 404) for example purposes, one of which enables data transfer and the other being configured to receive power supply from data processing device 100. In another example embodiment, one USB interface 402 may be used to enable data transfer from external processor 180 to data processing device 100 (e.g., processor 102) of FIG. 1, and the other USB interface 404 may be used to enable data transfer from data processing device 100 (e.g., processor 102) to external processor 180. In yet another example embodiment, the use of USB 3.0 may enable bidirectional and high-speed data transfer between data processing device 100 (e.g., processor 102) and external processor 180.

In the embodiments discussed in FIG. 3 and FIG. 4, the need for a fan to cool external processor 180 may be dispensed with by the use of heat sink 302 because of the open-air feature thereof. In one or more embodiments, the utilization of external processor 180 may enable performing of tasks associated with processor 102 and/or distribution of tasks associated with processor 102 such that heating of data processing device 100 may be reduced. In one or more embodiments, external processor 180 may be advantageously utilized in the case of data processing device 100 with low processing power to boost processing performance thereof without resorting to internal hardware changes. Thus, user 150 of data processing device 100 may play high-end games and/or enjoy videos without needing to change hardware therewithin.

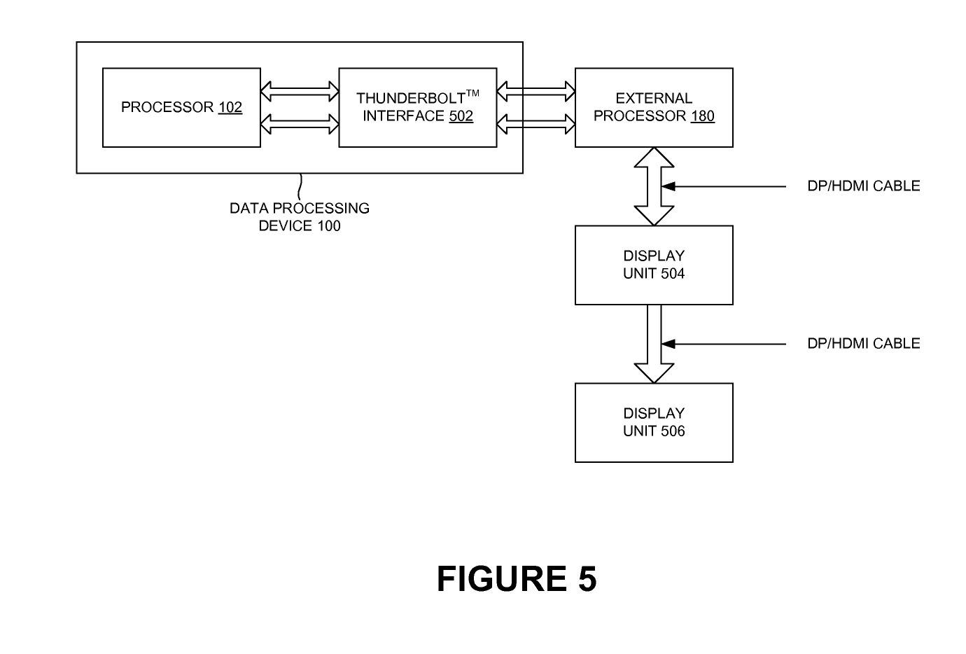

FIG. 5 shows an example embodiment of data processing device 100 with external processor 180 being coupled thereto through a Thunderbolt™ interface 502 (example interface 112). Here, external processor 180 may be powered through a Thunderbolt™ cable. Also, data transfer discussed above may also occur through a Thunderbolt™ cable. Thunderbolt™ interface 502 may be a single interface or a multiple interface. In the case of two Thunderbolt™ interfaces (e.g., Thunderbolt™ interface 502) being used, one Thunderbolt™ interface may be utilized to power external processor 180 and the other Thunderbolt™ interface may be utilized for data transfer.

When external processor 180 is coupled to Thunderbolt™ interface, external processor 180 may be recognized either as a display interface or an interface analogous to a PCIe. Because of this, driver component 204 may be required to enable operating system 106 interpret external processor 180 appropriately. A display unit 504 (e.g., same as display unit 110, different display unit) may be coupled to external processor 180 through, for example, a DP/HDMI cable. The aforementioned implementation may also enable daisy-chain coupling of display units. FIG. 5 shows another display unit 506 being coupled to display unit 504 through a DP/HDMI cable.

It is obvious that the USB/Thunderbolt™ implementations discussed above should not be considered limiting. Exemplary embodiments incorporate all kinds of USB standards such as USB 2.0, USB 3.0, Mini USB and Micro USB within the scope thereof. All current and/or future connectors utilizing the USB protocol to interface between devices, Thunderbolt™ ports, high-speed I/O interfaces, adapters utilized to couple to USB/Thunderbolt™ interfaces from other interfaces (e.g., ExpressCard® to USB 3.0) etc. are to be considered pertinent to the scope of the exemplary embodiments. The ports/interfaces provided through external processor 180 are not limited to DP and HDMI. Others such as Digital Visual Interface (DVI) are also pertinent to the exemplary embodiments. Further, it is obvious that external processor 180 may be coupled to display unit 306 wirelessly in addition to wired means.

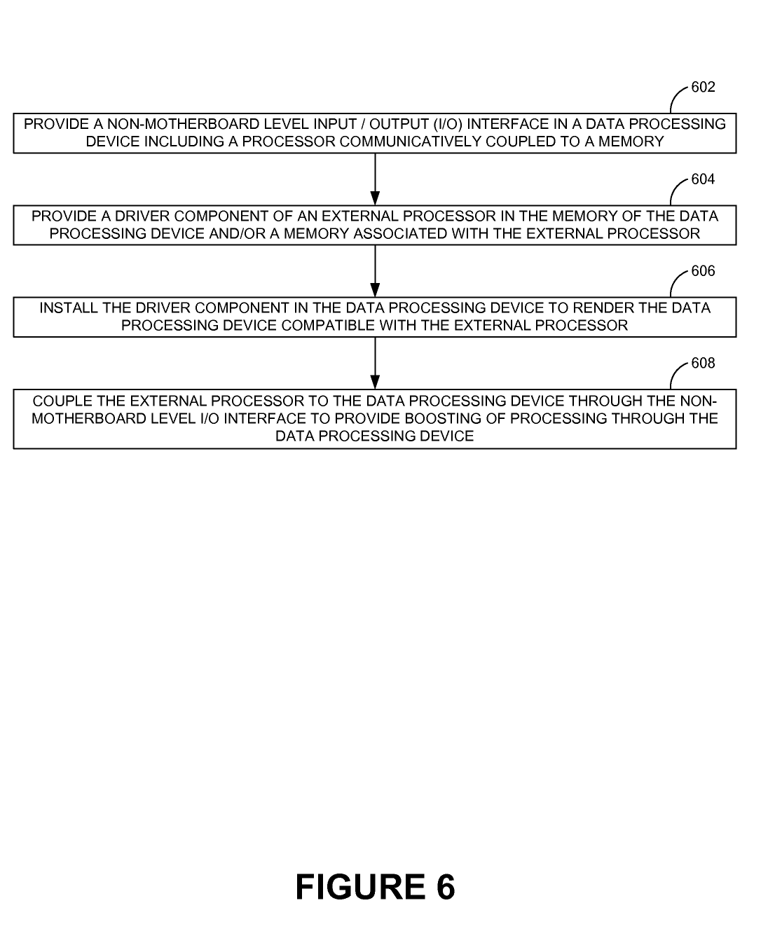

FIG. 6 shows a process flow diagram detailing the operations involved in a method of externally boosting processing through data processing device 100, according to one or more embodiments. In one or more embodiments, operation 602 may involve providing a non-motherboard level I/O interface (e.g., interface 112) in data processing device 100 including processor 102 communicatively coupled to memory 104. In one or more embodiments, operation 604 may involve providing driver component 204 of external processor 180 in memory 104 of data processing device 100 and memory 202 associated with external processor 180. In one or more embodiments, operation 606 may involve installing driver component 204 in data processing device 100 to render data processing device 100 compatible with external processor 180. In one or more embodiments, operation 608 may then involve coupling external processor 180 to data processing device 100 through the non-motherboard level I/O interface to provide boosting of processing through data processing device 100, thereby dispensing with a need to make a motherboard level modification in data processing device 100 therefore.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., a system including data processing device 100), and may be performed in any order (e.g., including using means for achieving the various operations). Accordingly, the specification and drawings are to be regarded in an illustrative rather than a restrictive sense.

What is claimed is:

1. A method comprising:
providing a non-motherboard level Input/Output (I/O) interface in a data processing device including a processor communicatively coupled to a memory;
providing a driver component of an external processor in at least one of the memory of the data processing device and a memory associated with the external processor;
installing the driver component in the data processing device to render the data processing device compatible with the external processor; and
coupling the external processor to the data processing device through the non-motherboard level I/O interface to provide boosting of processing through the data processing device, thereby dispensing with a need to make a motherboard level modification in the data processing device therefore.

2. The method of claim 1, wherein when the driver component is resident in the memory associated with the external processor and when the external processor is coupled to the data processing device, the method comprises at least one of:
reading, through an operating system executing on the data processing device in conjunction with the processor thereof, device information of the external processor;
assigning a unique identifier to the external processor through the operating system in conjunction with the processor of the data processing device following the reading of the device information;
loading the driver component from the memory associated with the external processor into the memory of the data processing device following the assignment of the unique identifier; and
installing the driver component from the memory of the data processing device to enable identification of the external processor during a subsequent coupling thereof to the data processing device through the non-motherboard level I/O interface.

3. The method of claim 1, further comprising providing a heat sink associated with the external processor to enable cooling thereof.

4. The method of claim 1, comprising providing one of a Universal Serial Bus (USB) based interface and a Thunderbolt™ based interface as the non-motherboard level I/O interface.

5. The method of claim 1, wherein when the data processing device includes a plurality of non-motherboard level I/O interfaces, the method comprises one of:
utilizing one non-motherboard level I/O interface to enable data transfer between the data processing device and the external processor and another non-motherboard level I/O interface to receive power supply from data processing device; and
utilizing the one non-motherboard level I/O interface to enable data transfer from the external processor to the data processing device and the another non-motherboard level I/O interface to enable data transfer from the data processing device to the external processor.

6. The method of claim 1, comprising utilizing the non-motherboard level I/O interface to enable bidirectional and high-speed data transfer between the data processing device and the external processor.

7. The method of claim 1, comprising at least one of:
providing a capability to interface the external processor with a display unit to render data therefrom; and
providing a capability to directly interface the non-motherboard level I/O interface of the data processing device with the display unit in order to render data thereon.

8. The method of claim 7, further comprising providing a capability to couple another display unit with the display unit in a daisy-chain configuration.

9. A system comprising:
a data processing device comprising:
a memory;
a processor communicatively coupled to the memory; and
a non-motherboard level I/O interface; and
an external processor having a memory associated therewith, at least one of the memory of the data processing device and the memory associated with the external processor including a driver component of the external processor therein, the driver component being installed in the data processing device to render the data processing device compatible with the external processor, and the external processor being configured to be coupled to the data processing device through the non-motherboard level I/O interface to provide boosting of processing through the data processing device, thereby dispensing with a need to make a motherboard level modification in the data processing device therefore.

10. The system of claim 9, wherein when the driver component is resident in the memory associated with the external processor and when the external processor is coupled to the data processing device, at least one of:
device information of the external processor is read through an operating system executing on the data processing device in conjunction with the processor thereof, a unique identifier is assigned to the external processor through the operating system in conjunction with the processor of the data processing device following the reading of the device information, the driver component is loaded from the memory associated with the external processor into the memory of the data processing device following the assignment of the unique identifier, and the driver component is installed from the memory of the data processing device to enable identification of the external processor during a subsequent coupling thereof to the data processing device through the non-motherboard level I/O interface.

11. The system of claim 9, wherein the external processor further comprises a heat sink associated therewith to enable cooling thereof.

12. The system of claim 9, wherein the non-motherboard level I/O interface of the data processing device is one of a USB based interface and a Thunderbolt™ based interface.

13. The system of claim 9, wherein when the data processing device includes a plurality of non-motherboard level I/O interfaces, one of:
one non-motherboard level I/O interface is utilized to enable data transfer between the data processing device and the external processor and another non-motherboard level I/O interface is utilized to receive power supply from data processing device, and
the one non-motherboard level I/O interface is utilized to enable data transfer from the external processor to the data processing device and the another non-motherboard level I/O interface is utilized to enable data transfer from the data processing device to the external processor.

14. The system of claim 9, wherein the non-motherboard level I/O interface of the data processing device is utilized to enable bidirectional and high-speed data transfer between the data processing device and the external processor.

15. The system of claim 9, wherein at least one of:
the external processor is capable of being interfaced with a display unit to render data therefrom, and
the data processing device is capable of directly interfacing with the display unit through the non-motherboard level I/O interface in order to render data on the display unit.

16. The system of claim 15, further comprising another display unit coupled with the display unit in a daisy-chain configuration.

17. A system comprising:
a data processing device comprising:
a memory;
a processor communicatively coupled to the memory; and
a non-motherboard level I/O interface; and
an external processing boosting device including an external processor having a memory associated therewith, the memory including a driver component of the external processor stored therein,
wherein when the external processing boosting device is coupled to the data processing device through the non-motherboard level I/O interface, device information of the external processing boosting device is read through an operating system executing on the data processing device in conjunction with the processor thereof,
wherein the operating system of the data processing device in conjunction with the processor thereof is configured to assign a unique identifier to the external processing boosting device following the reading of the device information,
wherein the driver component is loaded from the memory associated with the external processor into the memory of the data processing device following the assignment of the unique identifier, and
wherein the driver component is configured to be installed from the memory of the data processing device to enable identification of the external processor during a subsequent coupling thereof to the data processing device through the non-motherboard level I/O interface, thereby enabling the external processing boosting device to provide boosting of processing through the data processing device, with a need to make a motherboard level modification in the data processing device therefore being dispensed with.

18. The system of claim 17, wherein the external processing boosting device further comprises a heat sink associated with the external processor to enable cooling thereof.

19. The system of claim 17, wherein the non-motherboard level I/O interface of the data processing device is one of a USB based interface and a Thunderbolt™ based interface.

20. The system of claim 17, wherein the non-motherboard level I/O interface enables bidirectional and high-speed data transfer between the data processing device and the external processor of the external processing boosting device.
